(19) United States
(12) Patent Application Publication
(10) Pub. No.: US 2020/0116906 A1
(43) Pub. Date: Apr. 16, 2020

(54) ELEMENT FOR MANIPULATING LIGHT

(71) Applicant: Carl Freudenberg KG, Weinheim (DE)

(72) Inventors: Michael Roth, Mainz (DE); Ulrich Schneider, Darmstadt (DE); Sueleyman Altuncu, Mannheim (DE); Sarah Senne, Fuerth (DE); Jochen Bialek, Ilvesheim (DE)

(21) Appl. No.: 16/500,826

(22) PCT Filed: Apr. 4, 2018
(86) PCT No.: PCT/EP2018/058520

§ 371 Date: Oct. 4, 2019

(30) Foreign Application Priority Data
Apr. 6, 2017 (DE) 10 2017 003 362.5

(51) Int. Cl. G02B 5/02; D21H 13/24

(52) U.S. Cl. CPC G02B 5/0247; G02B 5/0221; D21H 13/24; G02B 5/0268

(57) ABSTRACT

A method of using a non-woven material, preferably a wet-laid non-woven material, as a light-distribution element, includes: providing the non-woven material, the non-woven material including: (a1) 1-50 wt % matrix fibers; (a2) 50-99 wt % of at least partially thermally fused binder fibers; and (b) 20-200 wt % of at least one filler polymer. The proportions by weight of matrix fibers, at least partially thermally fused binder fibers, and at least one filler polymer in each case relate to a total weight of the non-woven material without the at least one filler polymer The matrix fibers include at least one matrix fiber polymer and the at least partially thermally fused binder fibers include at least one binder fiber polymer. The at least one matrix fiber polymer and/or at least one binder fiber polymer independently of one another have a refractive index “n” of 1.3 to 1.7.

### CROSS-REFERENCE TO PRIOR APPLICATIONS

This application is a U.S. National Phase application under 35 U.S.C. § 371 of International Application No. PCT/EP2018/058520, filed on Apr. 4, 2018, and claims benefit to German Patent Application No. DE 10 2017 003 362.5, filed on Apr. 6, 2017. The International Application was published in German on Oct. 11, 2018 as WO 2018/185119 under PCT Article 21(2).

### FIELD

The invention relates to the use of a non-woven material as a light-distribution element, and a light source comprising such a light-distribution element.

### BACKGROUND

Punctiform light sources, such as LED lamps, are an energy-efficient illumination method in many applications. At the same time, however, it is desirable in many cases to illuminate an area or a space as homogeneously as possible, with a uniform distribution of light intensity. Various distribution and/or diffusion media, such as paper, special optical films, or textiles, may be used to achieve this goal. In addition to a uniform light distribution, further light manipulations, such as a collimation of the light or a particular ratio of reflection and transmission, are desired in many applications.

Paper media are very cost-effective diffusion elements which, however, have only a low luminance. Significantly higher luminances can be achieved by using special optical films. However, they have the disadvantage that they generally consist of only one type of material. For light manipulation, however, it is often necessary to bring materials with different refractive indices and other properties very close together. Although specific optical properties can be set for films by the incorporation of additives, by the implementation of subsequent surface treatments or by the lamination of a plurality of layers, this does call for further cost-intensive process steps. Furthermore, in the case of multilayer special films, the problem also arises of potential delamination or deformation due to different coefficients of thermal expansion of the materials used, in particular under the influence of heat.

Against this background, the use of textile materials, and in particular of non-woven materials, as light-distributing elements has proven to be favorable, since the most diverse structural and material compositions can be produced in a simple manner by a suitable choice of fiber mixture, non-woven material laydown and non-woven material bonding in a single process sequence. In this way, assuming good performance, manufacturing costs can be kept low in comparison with other diffusion media.

WO 2013/012974 A1 discloses a light source which comprises an illuminant, a light guide plate and a diffusion plate. The diffusion plate can consist of a non-woven material with a specific weight per unit area.

WO 2013/116193 A1 describes a display system in which a diffusion element made of non-woven material is arranged between the light source and the LCD screen.

WO 2006/129246 A2 describes a light source which has an illuminant arranged on a substrate and a light-distribution element made of non-woven material with a specific density setting.

In the documents cited, the light system is in each case in the foreground. As regards setting the non-woven material's properties in order to optimize light-diffusion properties, no adequate technical information is available.

EP 1891620 B1 discloses a light source, whose beam path of emitted light is broadened by a multilayer non-woven material element. In this case, the multilayer non-woven material element has a gradient in the material density (in the z direction) in order firstly to create a greater distance to the light source and secondly to make the light diffuse. This gradient is obtained by the use of a plurality of non-woven material layers on top of each other which form the scattering medium. The gradient is created as follows: A first layer of non-woven material having a low material density, which is placed next to the light source, is combined with a second denser layer of non-woven material that scatters the light.

A disadvantage of the homogeneous, anisotropic non-woven materials described in this document is that although they can scatter the light well, they do at the same time greatly reduce the transmitted light flux. The combination of a plurality of textile non-woven material layers reduces light transmittance even more, which is disadvantageous for the luminance of a surface light source. In addition, the use of a plurality of layers has the disadvantage that between the individual layers of non-woven material wrinkles can form which prevent homogeneous light propagation and reduce optical quality. This can, inter alia, lead to shadow-casting within a light element. In addition, the overall depth of a light source is increased by a multilayer structure, which entails a disadvantage in the production of compact, flat displays.

WO 2015/135790 A1 describes the use of a non-woven material as light-distribution element and also a light source comprising such a light-distribution element. The non-woven material here consists of a homogeneous polyester wet-laid non-woven material consisting of matrix fibers and binder fibers with good light-diffusion properties.

The disadvantage of the non-woven material described is that, although it does indeed have good light diffusion properties, light transmittance values are low, which significantly worsens the luminous efficiency of the light source mentioned here and thus leads to an increased energy requirement during operation of the light source in order for the same amount of light to be emitted.

WO 2013/142084 A1 describes a special optical film with precisely defined surface structures. These special films, often multilayered, can be adjusted to meet different optical requirements via the geometry of the surface structures, material compositions and various additives.

A disadvantage of these films is that they must have a complex structure in order to deliver the desired optical properties. In the case of non-woven material production, various structural and material compositions can be created in a single process sequence via the fiber blend, the variant of non-woven material laydown, and the type of non-woven material bonding. Although films can also be given specific optical properties by means of additives, subsequent surface treatment or lamination of a plurality of layers, this does call for further cost-intensive process steps. In addition, the lamination of different films repeatedly results in interfaces between the films which lead to undesired optical refractions, negatively affecting the function of the subsequent structures. In the case of multilayer special films, the problem also arises of potential delamination or deformation due to different coefficients of thermal expansion of the materials used, in particular under the influence of heat.

Another disadvantageous aspect is that although films basically have good optical properties, they only have good optical properties when they are entirely undamaged. However, the processing of such films often results in defects, in particular of a mechanical nature. These can be kinks, contamination and the like, which can then lead to optical flaws in a luminaire.

WO 2017/031659 A1 discloses a diffuser element comprising: (a) a non-woven material having fibers with a diameter of less than about 50 μm and a fiber aspect ratio of length/diameter greater than about 5, and (b) a porous resin coating on the surfaces of the fibers of the non-woven material. The porous resin coating has resin pores 200 nm to 2 μm in diameter. These pore sizes lead to low Gurley counts (<200 sec/100 ml) and have the disadvantage of increasing the number of scattering centers.

DE 10 2014 003 418 A1 discloses the use of a wet-laid non-woven material, which contains

(a1) 5-50 wt % matrix fibers and

(a2) 50-95 wt % at least partially thermally fused binder fibers, or

(b1) 50-80 wt % matrix fibers and

(b2) 20-50 wt % binder, known as light-distribution element.

This non-woven material already has excellent light-diffusion properties. However, for some applications it is desirable that luminance be increased.

### SUMMARY

In an embodiment, the present invention provides a method of using a non-woven material, preferably a wet-laid non-woven material, as a light-distribution element, comprising: providing the non-woven material, the non-woven material comprising: (a1) 1-50 wt % matrix fibers; (a2) 50-99 wt % of at least partially thermally fused binder fibers; and (b) 20-200 wt % of at least one filler polymer, wherein the proportions by weight of matrix fibers, at least partially thermally fused binder fibers, and at least one filler polymer in each case relate to a total weight of the non-woven material without the at least one filler polymer, wherein the matrix fibers comprise at least one matrix fiber polymer and the at least partially thermally fused binder fibers comprise at least one binder fiber polymer, wherein the at least one matrix fiber polymer and/or at least one binder fiber polymer independently of one another have a refractive index “n” of 1.3 to 1.7, wherein the at least one filler polymer has a refractive index “n” of 1.2 to 1.7, wherein a difference between the refractive index of the at least one matrix fiber polymer and the refractive index of the at least one filler polymer and/or a difference between the refractive index of the at least one binder fiber polymer and the refractive index of the at least one filler polymer is from 0.1 to 0.4, and wherein the non-woven material has a Gurley count >250 sec/100 ml.

### DETAILED DESCRIPTION

In an embodiment, the present invention provides a light-distribution element which, in addition to having very good light-diffusion properties, also has a high luminance or a high light transmittance. Moreover, the light-distribution element should combine very good light-intensity distributions of punctiform and/or linear light sources, such as LEDs and/or CCFLs, with inexpensive production. This object is achieved according to the invention by the use of a non-woven material, preferably a wet-laid non-woven material, as a light-distribution element, wherein the non-woven material has
(a1) 1-50 wt % matrix fibers,
(a2) 50-99 wt % of at least partially thermally fused binder fibers, and
(b) 20-200 wt % of at least one filler polymer, wherein the proportions by weight of matrix fibers, binder fibers and filler polymer in each case relate to the total weight of the non-woven material without filler polymer, and wherein
   the matrix fibers contain at least one matrix fiber polymer and the binder fibers contain at least one binder fiber polymer,
   the matrix fiber polymers and/or binder fiber polymers independently of one another have a refractive index “n” of 1.3 to 1.7, preferably 1.5 to 1.65,
   the filler polymer has a refractive index “n” of 1.2 to 1.7,
   the difference between the refractive index of the matrix fiber polymer and the refractive index of the filler polymer and/or the difference between the refractive index of the binder fiber polymer and the refractive index of the filler polymer is 0.1 to 0.4, and
   the non-woven material has a Gurley count >250 sec/100 ml.

Surprisingly, it has been found that the non-woven material according to the invention has very high luminance values without the good light-diffusion properties of the non-woven material being impaired. A further advantage of the non-woven material according to the invention is that it has a particularly high uniformity. This is reflected, for example, in a very uniform impression of brightness (luminance, [L]=cd/m2). This is evident in luminance measurements over a defined area using a spatially resolving luminance camera. The result of this is that the individual luminance values L (x, y) within a defined area have a low scatter (standard deviation σ). This is equivalent to a very homogeneous illumination of a surface.

According to the invention, the non-woven material has a Gurley count of more than 250 sec/100 ml, for example from 250 sec/100 ml to 5000 sec/100 ml, preferably 300 sec/100 ml to 5000 sec/100 ml, more preferably from 400 sec/100 ml to 5000 sec/100 ml, in particular from 500 sec/100 ml to 5000 sec/100 ml. This can be achieved through a very low porosity and pore size of the filler polymer in the non-woven material according to the invention, such that, for example, pore sizes from 0.1 nm to 150 nm, preferably from 1 nm to 100 nm, are obtained. On the other hand, pore sizes from 1 to 5 μm give Gurley counts of 1 to 100 sec/100 ml air. In a preferred embodiment of the invention, the non-woven material has a porosity of less than 40%, for example from 1 to 40% and/or of less than 30%, for example from 5 to 30% and/or from 10 to 30%.

Filler polymers with low Gurley counts have the disadvantage of introducing additional interfaces, which would increase scattering excessively, which according to the invention is not desired.

It has been found in practical experiments that with the non-woven material according to the invention it is possible to obtain average luminance values of more than 2200 cd/m², for example from 2200 cd/m² to 3500 cd/m², without light-diffusion properties substantially deteriorating. Surprisingly, it is even possible to reduce the scatter of the luminance by applying the filler polymer. The non-woven material according to the invention can thus have a scatter sigma of less than 180 cd/m², for example from 50 cd/m² to 180 cd/m², preferably from 80 cd/m² to 150 cd/m².

This is surprising because it had been expected that increasing the number of interfaces by adding the filler polymer would have a negative impact on the optical properties of the non-woven material. In particular, it had been expected that a significant loss of light intensity, accompanied by a lower transmission, should occur due to reflection at the interfaces between the filler polymer (b) and the fibers (a1) and (a2). However, this is surprisingly not the case.

Without wishing to stipulate a mechanism according to the invention, it is assumed that the unexpectedly good light transmission properties of the non-woven material are attributable to the fact that the use of the filler polymer having a refractive index “n” of 1.2 to 1.7, preferably 1.4 to 1.65, more preferably 1.4 to 1.55 and in particular 1.4 to 1.5 results in only a few total reflections of the light occurring within the non-woven material. Here the refractive index is measured in accordance with DIN EN ISO 489:1999-08.

In addition, the non-woven material has excellent light-diffusion properties. This, in turn, was surprising in view of the unexpectedly high transmission since good transmission properties usually lead to poorer light-diffusion properties.

Surprisingly high luminance values can be achieved with the non-woven material according to the invention, together with constant diffusion of the light and good light-intensity distributions of punctiform light sources, such as for example LEDs.

A further advantage of the non-woven material according to the invention can be seen in the fact that it has a very high uniformity; this is reflected, for example, in a very uniform light transmission across the surface.

The good mechanical properties of the non-woven material according to the invention are likewise advantageous. The non-woven material according to the invention is preferably characterized by a tear propagation strength in at least one direction of more than 0.6 N, for example from 0.6 N to 1.5 N and/or from 0.7 N to 1.5 N. A high tear propagation resistance is advantageous, for example, when installing the non-woven material according to the invention in a light source, for example when clamping it into an LCD screen, since this is accompanied by a high mechanical level of stress.

Furthermore, the non-woven material according to the invention is preferably characterized by a high tensile strength in at least one direction of more than 180 N, for example from 180 N to 400 N, and/or from 190 N to 400 N.

Also advantageous in the non-woven material according to the invention is its low shrinkage, which is advantageously less than 2%, for example from 0.1% to 2%.

According to the invention the matrix fibers contain a matrix fiber polymer with a refractive index “n” from 1.3 to 1.7, particularly preferably from 1.5 to 1.65 and/or the binder fibers contain a binder fiber polymer with a refractive index “n” from 1.3 to 1.7, particularly preferably from 1.5 to 1.65, and the filler polymer has a refractive index “n” from 1.2 to 1.7. The matrix fibers advantageously contain the matrix fiber polymer in a proportion of at least 90 wt %, more preferably from 95 to 100 wt %, even more preferably from 97 to 100 wt %, and/or the binder fibers advantageously contain the binder fiber polymer in a proportion of at least 20 wt %, more preferably from 20 to 80 wt %, and in particular from 30 to 70 wt % (provided the binder fibers are present as multicomponent fibers) and/or the binder fibers advantageously contain the binder fiber polymer in a proportion of at least 90 wt %, more preferably from 95 to 100 wt %, even more preferably from 97 to 100 wt % (provided the binder fibers are present as monocomponent fibers). The use of a matrix fiber polymer and/or binder fiber polymer having a refractive index “n” from 1.3 to 1.7 is advantageous in that it has good transmission properties, in particular in combination with the filler polymer.

According to the invention, the filler polymer has a refractive index “n” from 1.2 to 1.7, preferably from 1.4 to 1.65, more preferably from 1.4 to 1.55 and in particular from 1.4 to 1.5. The use of a filler polymer having the above-mentioned refractive index is advantageous in that it has good transmission properties, in particular in combination with the fibers and binders used according to the invention.

According to the invention, the difference between the refractive index of the matrix fiber polymer and/or of the binder fiber polymer on the one hand and the refractive index of the filler polymer on the other hand is from 0.1 to 0.4, and/or from 0.1 to 0.35, and/or from 0.1 to 0.3. It is advantageous in setting a comparatively large difference in the refractive indices of the aforementioned components that diffusion can thereby be improved.

The filler polymer may be present on one or both sides of the non-woven material as a flat coating and/or be present partly in the interior of the non-woven material. A flat coating is to be understood to mean that more than 90%, preferably 95% to 100%, particularly preferably 98% to 100% of the surface of the non-woven material is covered with the filler polymer. According to the invention, the filler polymer is preferably present not only as a flat coating but also at least partially in the interior of the non-woven material, in particular in the fiber interspaces, since this allows a particularly good transmission within the non-woven material to be achieved.

The filler polymer can act as a binder and thus contribute to the strength of the non-woven material. This function can be fulfilled, for example, when it is introduced into a fibrous web and then cured. Preferably, however, the filler polymer does not or does not substantially function as a binder.

In a preferred embodiment of the invention, the filler polymer is selected from the group consisting of polyacrylates, polymethacrylates, polyurethane acrylates, polyurethane methacrylates, polyurethanes, polyamides, polyvinyledene fluoride (PVDF), polyether ether ketone (PEEK), polycarbonate (PC), polyolefins (PO), cyclic polyolefin copolymers (COC) and mixtures thereof.

The filler polymers, preferably the aforementioned filler polymers, can also be used in the form of homopolymers or as copolymers. Examples of suitable copolymers are statistical copolymers, gradient copolymers, alternating copolymers, block copolymers or graft copolymers. The copolymers may consist of two, three, four or more different monomers (terpolymers, tetrapolymers).

The filler polymer is particularly preferably selected from the group consisting of polyacrylates, polymethacrylates, polyurethane acrylates and polyurethane methacrylates, polyurethanes and copolymers thereof, in particular styrene acrylates, and mixtures.

According to the invention, the acrylates and methacrylates are preferably prepared by means of a free-radical polymerization, preference being given to using, as monofunctional monomers, beta-unsaturated carboxylic acids, their salts, their esters, amides or nitriles. In this case, a double bond or triple bond is present at the beta position. The esters and acids preferably have the general formula R1R2C═C—COOR3. Here R1, R2 and R3 are organic groups or H. The organic groups are in particular alkyl, aryl and alkaryl. The alkyl groups, in particular R3, are in particular unbranched or branched C1 to C20 groups, preferably methyl, ethyl, propyl, isopropyl, ethyl-2-n-propyl, benzyl-2-n-propyl, butyl, isobutyl, pentyl, hexyl, octyl, ethylhexyl, decyl, isodecyl, stearyl, lauryl, cyclohexyl, isobornyl, 2-hydroxyethyl, ethoxy-ethoxy, furfuryl, tetrahydrofurfuryl, or aryl groups such as benzyl, phenyl and phenoxyethyl. Preference is also given to those compounds which have an amide group instead of the ester group.

In preferred embodiments of the invention, the monofunctional monomers are acrylates, methacrylates, acrylamides, methacrylamides or derivatives thereof. Suitable monomers are, for example, esters of acrylic acid and methacrylic acid and derivatives thereof, wherein the ester component has up to 20 C atoms in the group, such as methyl, ethyl, propyl, isopropyl, ethyl 2-n-propyl, benzyl 2-n-propyl, butyl, isobutyl, pentyl, hexyl, octyl, ethylhexyl, decyl, isodecyl, stearyl, lauryl, cyclohexyl, isobornyl, phenyl, benzyl, phenoxyethyl, 2-hydroxyethyl, ethoxy-ethoxy, furfuryl, tetrahydrofurfuryl.

Particularly preferred are in particular methyl, ethyl, propyl, isopropyl, ethyl 2-n-propyl, benzyl 2-n-propyl, butyl, isobutyl, pentyl, hexyl, octyl, ethylhexyl acrylates; ethylene glycol methyl ether acrylate, ethylene glycol dicyclopentenyl ether acrylate, poly (ethylene glycol) methyl ether acrylates with a molecular weight of about 200 to 500, poly(propylene glycol) acrylates with a molecular weight of about 200 to 500.

It is also possible to use mixtures of the monomers referred to.

According to the invention, the filler polymer is preferably prepared by means of a free-radical polymerization, it also being possible to use bifunctional or polyfunctional monomers in addition to the monofunctional monomers. Suitable bifunctional or polyfunctional monomers for free-radical polymerization are, in particular, compounds which can polymerize and/or crosslink at two or more locations in the molecule. A network can thereby form during polymerization. Such compounds preferably have two identical or similar reactive functionalities. Alternatively, compounds having at least two differently reactive functionalities can be used. In this way, one reactive group can polymerize and the other reactive group, which did not participate in the polymerization, can be selectively crosslinked.

The filler polymer could have been made from a filler polymer educt having a melting point and/or the softening point below the melting point of the matrix fiber polymer and/or the binder fiber polymer. The filler polymer can thereby coat well with film, which makes homogeneous optical properties possible.

In a preferred embodiment of the invention, the filler polymer is selected and/or combined in such a way that its glass transition point, film formation temperature or its melting point makes it possible to adjust the film formation of the coating in such a way that the optical properties can be adapted to a specific application.

The amount in which the filler polymer is present in and/or on the non-woven material can vary depending on its desired properties. Amounts in the range of 20 wt % to 200 wt % have proven suitable, more preferably 25 wt % to 200 wt %, even more preferably 30 wt % to 200 wt %, particularly preferably 51 wt % to 200 wt %, the proportions by weight in each case relating to the total weight of the non-woven material without filler polymer.

Furthermore, the non-woven material according to the invention can also have light-scattering fillers with a very high refractive index of preferably more than 1.6 or special optical properties. These materials can be present embedded in the filler polymer, for example. In particular not only Al₂O₃, silicates, zirconates and titanium oxides have proven suitable for this purpose but also fluorescent or phosphorescent materials. These materials make it easier to obtain adequate light-scattering properties even with low thicknesses and coating quantities. If present, the non-woven material comprises the aforementioned materials in an amount of at least 0.1 wt %, for example, from 0.1 wt % to 5 wt %, based on the total weight of the non-woven material without filler polymer.

The non-woven material used according to the invention comprises matrix fibers and/or binder fibers. Matrix fibers are to be understood according to the invention as fibers which, in contrast to the binder fibers, have not been thermally melted or only insignificantly thermally melted. The matrix fibers can only consist of one fiber type or contain fiber mixtures. In contrast, the binder fibers in the non-woven material are at least partially thermally fused with themselves and/or with the matrix fibers. In this case, the binder fibers can consist only of one fiber type or contain fiber mixtures. It is also conceivable for the binder fibers to comprise thermally fused and non-fused fiber components, for example if they are core-sheath fibers. In this case, only the thermally fused component (e.g. the sheath) is to be regarded as a binder fiber polymer and the non-fused component (e.g. the core) as a matrix fiber polymer.

According to the invention, the matrix fibers and the binder fibers (a) are preferably staple fibers and/or short-cut fibers. According to the invention, unlike filaments that have a theoretically unlimited length, staple fibers are to be understood as meaning fibers that have a limited length, preferably 1 mm to 90 mm, more preferably 1 mm to 30 mm. According to the invention, short-cut fibers are to be understood as meaning fibers with a length of preferably 1 mm to 12 mm, more preferably 3 mm to 6 mm.

According to the invention, the binder fibers are at least partially fused in the non-woven material, which likewise has an advantageous influence on luminance. The binder fibers may have regions that are fused and regions that are not fused. According to the invention, the binder fibers are preferably fused at at least some fiber intersections, preferably at at least 40%, or at at least 50%, or at at least 60%, or at at least 70%, or at at least 80%, or at at least 90% of the intersection points.

According to the invention, the matrix fibers preferably take the form of staple fibers and/or short-cut fibers. The matrix fibers may be mono- or multicomponent fibers. For cost reasons, it may be preferable to use mono-component fibers. The fiber lengths are advantageously from 1 mm to 30 mm, even more preferably from 2 mm to 12 mm and in particular from 3 mm to 6 mm.

According to the invention, the matrix fibers may contain a wide variety of matrix fiber polymers, preferably polyacrylonitrile, polyvinyl alcohol, viscose, cellulose, polyamides, in particular polyamide 6 and polyamide 6.6, preferably polyolefins and very particularly preferably polyesters, in particular polyethylene terephthalate, polyethylene naphthalate and polybutylene terephthalate, and/or mixtures thereof. The refractive index of the matrix fibers can thereby be specifically adjusted to the refractive index of the filler polymer.

The matrix fibers advantageously contain the above-mentioned materials in a proportion of more than 90 wt %, preferably 95 wt % to 100 wt %. Very particularly preferably, they consist of the above-mentioned materials, it being possible for the usual impurities and auxiliary agents to be present.

The proportion of matrix fibers according to the invention is preferably 1 to 50 wt %, preferably from 1 to 20 wt % and in particular from 1 to 10 wt %, in each case based on the total weight of the non-woven material without filler polymer.

The titer of the matrix fibers may vary depending on the desired structure of the non-woven material. The use of matrix fibers having an average titer of 0.06 to 1.7 dtex, preferably of 0.1 to 1.0 dtex, has proved to be particularly advantageous.

Practical tests have shown that the at least partial use of microfibers having an average titer of less than 1 dtex, preferably of 0.1 to 1 dtex, as matrix fibers has an advantageous effect on the size and structure of the pore sizes and inner surface and also on the density of the non-woven material. Proportions of at least 1 wt %, preferably from 1 wt % to 25 wt %, particularly preferably from 5 wt % to 10 wt %, based in each case on the total weight of the non-woven material without filler polymer, have proven to be particularly favorable. In this way, the optical properties of the non-woven material can be adjusted selectively, since the pore size and porosity decisively influence the filling with the filler polymer and thus have a direct influence on diffusion and transmission properties.

The matrix fibers can have a wide variety of shapes, for example be flat, hollow, round, oval, trilobal, multilobal, bicomponent, and/or islands-in-sea fibers. The cross-section of the matrix fibers is preferably round.

The fibers normally used for this purpose can be used as binder fibers provided they can be at least partially thermally fused. Binder fibers can be mono-component and/or also multicomponent fibers. Particularly suitable binder fibers according to the invention are fibers containing at least one binder fiber polymer having a melting point which is below the melting point of the matrix fibers to be bonded, preferably below 250° C., more preferably from 70 to 230° C., in particular from 150 to 225° C. Suitable binder fibers are in particular fibers which contain thermoplastic polyesters and/or copolyesters, in particular polybutylene terephthalate, polyolefins, in particular polypropylene, polyamides, polyvinyl alcohol or also copolymers as well as copolymers and mixtures thereof as binder fiber polymer.

Particularly suitable binder fibers according to the invention are multicomponent fibers, preferably bicomponent fibers, in particular core/sheath fibers. Core/sheath fibers contain at least two fiber polymers with different softening and/or melting temperatures. The core/sheath fibers preferably consist of these two fiber polymers. In this case, the component which has the lower softening and/or melting temperature is preferably found at the fiber surface (sheath) and that component which has the higher softening and/or melting temperature is preferably found in the core.

In core/sheath fibers, the bonding function may be exercised by the materials disposed on the surface of the fibers. Thus, in core/sheath fibers, the materials disposed on the surface of the fibers function as binder fiber polymers. A very wide variety of materials can be used for the sheath. Preferred materials for the sheath according to the invention are polybutylene terephthalate (PBT), polyamide (PA), polyethylene (PE) copolyamides and/or also copolyesters. A very wide variety of materials can likewise be used for the core. According to the invention, preferred materials for the core are polyesters (PES), in particular polyethylene terephthalate (PET) and/or polyethylene naphthalate (PEN) and/or polyolefins (PO).

The use of core/sheath binder fibers is preferred according to the invention since a particularly homogeneous distribution of the binder component in the non-woven material can thus be achieved.

In practical tests, non-woven materials with very good properties could be obtained with PET/PBT bicomponent fibers and/or PET/CoPES bicomponent fibers. Good results could also be achieved with fibers from the class of polyolefins, such as, in particular, polyethylene/polypropylene bicomponent fibers. PEN/PET bicomponent fibers could also be suitable.

However, the use of mono-component binder fibers is also conceivable, provided these can be at least partially thermally fused. Here the choice of mono-component binder fibers depends on the matrix fiber used. For example, polyamide 6 binder fibers are suitable for bonding polyamide 66 matrix fibers and copolyesters for bonding polyethylene terephthalate.

The average fiber lengths of the binder fibers are advantageously from 1 mm to 30 mm, more preferably from 1.5 mm to 12 mm, and in particular from 3.0 mm to 6.0 mm.

The proportion of binder fibers according to the invention is 50 to 99 wt %, preferably from 80 to 99 wt % and in particular from 90 to 95 wt %, in each case based on the total weight of the non-woven material without filler polymer.

The mean titer of the binder fibers may vary depending on the desired structure of the non-woven material. The use of binder fibers having an average titer of 0.2 to 2.2 dtex, preferably 0.8 to 1.3 dtex, has proven to be advantageous.

The binder fibers may be bonded to each other and/or to the matrix fibers of the non-woven material by thermofusion. Solidification in a hot-air conveyor furnace by means of a throughflow of hot air and/or on a drum through which hot air flows has proven to be particularly suitable.

Thickness calibration can be set between 2 smooth calender rollers.

The fibers used for producing the non-woven material can in principle be of different colors. However, transparent fibers are used in a preferred embodiment of the invention.

The cross-section of the binder fibers (at least before thermal solidification), irrespective of whether mono- or multicomponent fibers are present, can be round, oval, superficially grooved, star-shaped, ribbon-shaped, tri- or multilobal. According to the invention, the cross-section of the fibers is preferably round.

The fibers building up the non-woven material used according to the invention may have been mechanically or aerodynamically stretched or drawn. It is advantageous when using such fibers that oriented fibers have a low shrinkage, a higher modulus of elasticity and thus a preferably greater strength. It is also conceivable to add to the drawn fibers those of the same or a different matrix fiber polymer structure, which have been drawn only partially or not at all.

To control the diffusion properties of the non-woven material, the matrix fibers and/or binder fibers may further contain matting agents, such as titanium dioxide. For this purpose, in particular, proportions of 150 ppm to 10 wt % matting agent have proven suitable, based on the total weight of the non-woven material without filler polymer.

It is also conceivable to equip the non-woven material to be flame-retardant, for example with a phosphonic acid derivative. This reduces the risk of fire in the event of contact with hot light sources.

It is basically conceivable to use the non-woven material in the form of a layer composite. The further layers could take the form of reinforcing layers, for example in the form of a scrim, and/or comprise reinforcing filaments, non-woven materials, woven fabrics, knitted fabrics, laid scrims and/or films, in particular diffuser or light guide films. According to the invention, however, the non-woven material preferably has a single-layer structure, since this can prevent optical disturbances due to interfacial transitions.

The weights per unit area of the non-woven material used according to the invention can be adjusted depending on the specific application purpose. According to a preferred embodiment of the invention, the weight per unit area of the non-woven material, measured in accordance with DIN EN 29073, is advantageously from 30 to 600 g/m², more preferably from 35 to 500 g/m², even more preferably from 40 g/m² to 400 g/m², in particular from 55 to 200 g/m². It has been found that in these weight ranges, sufficient fiber mass is present for a non-woven material to be obtained that has adequate inherent rigidity and a flat layer (no depressions). In this context, too, it is advantageous if the non-woven material has a single-layer construction. In fact, single-layer non-woven materials demonstrate only a low tendency to wrinkle, since no layer stresses occur.

The thickness of the non-woven material measured according to test specification EN 29073-T2 is preferably from 30 to 400 μm, more preferably from 60 to 350 μm, even more preferably from 80 to 320 μm, and in particular from 110 to 320 μm.

Practical tests have shown that the luminance distribution can be improved by increasing the density of the non-woven material. In view of this, the density of the non-woven material (raw density calculated from weight per unit area and thickness) is preferably at least 0.4 g/cm³, for example 0.4 to 1 g/cm³, and more preferably 0.6 to 0.9 g/cm³. The density of the non-woven material can be increased, for example, by compaction/calendering steps in the production of the non-woven material.

The porosity of the non-woven material, calculated from the thickness, weight and densities of the materials used (P=(1−FG/(d-& δ))·100 where FG is the weight per unit area in kg/m², d the thickness in m and δ the density in kg/m³), is preferably less than 40%, for example from 1 to 40% and/or less than 30%, for example from 5 to 30% and/or from 10 to 30%.

In a preferred embodiment of the invention, the non-woven material is a wet-laid non-woven material, which can be produced by a wet-laying process. It is advantageous here that, in addition to the high levels of light transmission, very good light intensity distributions of punctiform light sources, such as LEDs, for example, are also achieved. Without stipulating a particular mechanism according to the invention, it is assumed that the high luminance values are attributable to the fact that the wet-laid non-woven materials, due to being produced by the wet-laid process, exhibit an extremely homogeneous and isotropic fiber structure, which is solidified very uniformly due to the high proportion of at least partially fused binder fibers. The high proportion of binder fibers also facilitates a good surface bonding of the fibers and a uniform bonding of the non-woven material over its cross-section, which likewise has an advantageous effect on the luminance.

The non-woven material used according to the invention can be produced by a method comprising the following steps:
Providing a fiber blend comprising matrix fibers and binder fibers, the matrix fibers containing at least one matrix fiber polymer and the binder fibers containing at least one binder fiber polymer, and the matrix fiber polymers and/or binder fiber polymers independently of each other having a refractive index “n” of 1.3 to 1.7, preferably 1.5 to 1.65;
Providing a filler polymer having a refractive index “n” from 1.2 to 1.7, wherein the difference between the refractive index of the matrix fiber polymer and the refractive index of the filler polymer and/or the difference between the refractive index of the binder fiber polymer and the refractive index of the filler polymer is from 0.1 to 0.4; and
Forming an aqueous fiber dispersion by dispersing in an aqueous medium the fiber mixture comprising matrix fibers and binder fibers;
Dewatering the fiber dispersion while forming a fibrous web;
Drying, thermally binding the fibrous web to solidify it into a wet-laid non-woven material;
Optionally calendering the wet-laid non-woven material to adjust and solidify the thickness thereof;
Applying the filler polymer to the wet-laid non-woven material to form the non-woven material with a Gurley count >250 sec/100 ml.

The aqueous fiber dispersion can be formed in a manner customary in the field of wet-laid non-woven material production by mixing the fibers with water.

In order to obtain a non-woven material which is as homogeneous and isotropic as possible, it is advantageous for the fibers to be well mixed and uniformly distributed before the fiber is laid.

To form the fiber dispersion, the binder fibers and matrix fibers are preferably used in such a quantity that the weight ratio of binder fibers to matrix fibers in the fiber dispersion is from 1:1 to 30:1, preferably from 5:1 to 20:1.

In addition to the fibers, the fiber dispersion can also contain further components, for example wetting agents, defoamers and/or customary additives.

Dewatering the fiber dispersion to form the fibrous web can likewise be effected in a manner customary in the field of wet-laid non-woven material production, for example by discharging the mixture onto a screen and extracting the water by suction.

Web formation is followed by a process step in which the fibrous web is dried and thermally bonded in order to obtain a wet-laid non-woven material.

The wet-laid non-woven material formed can then be calendered. Calendering effects a compaction of the wet-laid non-woven material and optionally an autogenous welding of the fibers or fiber components, which are melt-activated under the solidification conditions.

Calendering, if carried out, is effected by heat and pressure. Depending on the type of fibers used for the production of the wet-laid non-woven material, suitable temperatures are generally from 100 to 250° C.

In the case of polyolefin fibers being used, calendering temperatures are typically 100 to 160° C., depending on the particular olefinic fiber or fiber component used. The calendering conditions are to be matched very particularly to the melting and softening behavior of the matrix fiber polymers used in the individual case. When polyester binder fibers are used, the calendering temperatures are typically from 170 to 230° C.

The calender advantageously consists of two smooth rollers. In individual cases in which a structured surface is desired, a roller can also have an embossing pattern.

The filler polymer can be applied to the non-woven material in a wide variety of ways. A dispersion or solution of the polymer is preferably used in this case. Particularly preferred dispersions are film-forming and/or crosslinking dispersions or solutions. These can be applied to one or both sides of the wet-laid non-woven material, for example by means of impregnation and/or coating. Preference is given here to coating, for example by means of a roll coating method, since in this way a particularly continuous coating can be achieved. The filler polymer can form a film by drying. Most preferably, the filler polymer is applied to the non-woven material in the form of an aqueous polymer dispersion.

It is also preferred for the filler polymer to be prepared from precursor compounds. Suitable precursor compounds are monomers and/or oligomers which, after application to the wet-laid non-woven material, can be converted into the filler polymer, for example by UV polymerization. Monomers suitable for this embodiment are, in particular, those which can be polymerized by means of free-radical or cationic UV polymerization. It is very particularly preferred for these to be acrylates, methacrylates, acrylamides, methacrylamides, acrylic acid, methacrylic acid, polyurethane acrylates, but also styrene and its derivatives. In some cases it may be desirable to crosslink these also with crosslinkers, such as N,N′-methylenebisacrylamide (MBA) or even divinylbenzene (DVB). The advantage of this method is that there is a very good penetration of the non-woven material with the monomers.

Depending on the intended final application and the technical requirements thereof, the polymer can be applied by suitable selection of the technology such that the polymer is present in the most diverse areas, for example in the form of the coatings described below or combinations thereof:
Internal impregnation of the non-woven material (fiber interspaces)
Coating of one non-woven material surface (on the fibers) or both non-woven material surfaces

The non-woven material according to the invention is eminently suitable as a light-distribution element due to the high transmittance values achievable with it and at the same time its very good light-diffusion properties. The invention therefore further relates to a light-distribution element comprising a non-woven material in the form of one or more of the embodiments mentioned here.

A further subject-matter of the present invention is a light source comprising at least one illumination means and, as light-distribution element, a non-woven material as described above. An illumination means of this kind is distinguished by having a very high luminaire efficiency combined with a high degree of uniformity.

In particular, punctiform light sources, such as LEDs, and/or linear light sources, such as CCFLs (“cold-cathode fluorescent lamps”), are suitable as illumination means. Here LEDs is understood to mean light-emitting diodes that can emit light in wavelength ranges from infrared to UV light. LEDs are to be understood as covering the most varied types of light-emitting diodes, including organic, inorganic or laser-based diodes.

The light source according to the invention can be used for a very wide variety of lighting purposes, for example for room illumination and/or messaging. In a preferred embodiment of the invention, the light source is used for backlighting liquid-crystal displays (LCD).

### Measuring Methods:

### Refractive Index:

The refractive index of the materials used is determined in accordance with DIN EN ISO 489:1999-08.

### Weight Per Unit Area:

On the basis of test specification EN 29073-T1, to determine the weights per unit area 3 samples in each case measuring 100×100 mm are punched out, the samples weighed and the measured value multiplied by 100.

### Determination of the Proportions by Weight of Matrix Fibers, Binder Fibers and Filler Polymer:

First of all, the weight of the non-woven material without filler polymer (unfilled non-woven material) is determined and normalized to 100 wt %. The proportions by weight of matrix fibers, binder fibers and filler polymer are then determined and expressed in relation to the weight of the non-woven material without filler polymer.

Example: A non-woven material contains 30 g/m² matrix fibers, 50 g/m² binder fibers and 30 g/m² filler polymer. The sum of the matrix and binder fibers, being 80 g/m², corresponds to 100 wt %. The proportion by weight of the matrix fibers is therefore 37.5 wt %, the proportion by weight of the binder fibers is therefore 62.5 wt %, and the proportion by weight of the filler polymer is 37.5 wt %.

### Thickness:

Thicknesses are measured according to test specification EN 29073-T2. The measuring surface is 2 cm², the measuring pressure 1000 cN/cm².

### Porosity:

Porosities are calculated from the thickness, weight and densities of the materials used (P=(1−FG/(d-& δ))·100).

### Air Permeabilities According to Gurley:

Air permeabilities are determined in accordance with ISO 5636-3.

### Luminance:

Luminance is determined using an LED light box. The light box has the following dimensions: 275×400×275 mm (width×height×depth). On the height-adjustable floor of the light box, 36 (6×6) light-emitting diodes (SMD component, light color: warm white, luminous flux: 21 lm/LED, beam angle: 120°, operating voltage: 12 VDC) are mounted at a distance of 33.3 mm from each other. The transparent cover plate of the light box is made of acrylic glass 2.5 mm thick. To determine the luminance, the non-woven material to be measured is placed on the cover plate, the distance between the activated LED light source and the non-woven material here being 33 mm.

The luminance distribution in the darkened space is then recorded by the spatially resolving luminance camera at a distance of 1 m from the diffuser. The relevant parameters such as maximum, minimum, mean value and scatter can then be determined from the luminance values L (x, y) using software.

### Tear Propagation Resistance:

The tear propagation strengths of the non-woven materials are determined on the basis of test specification DIN 53859. For this purpose, in each case 3 specimens are punched out in MD and CD with dimensions of 75×50 mm and with a 50 mm notch. The legs of the test specimens formed by the notch are clamped in the clamping jaws of the tensile testing machine (clamp spacing 50 mm) and pulled apart at a withdrawal speed of 200 mm/min. Since membranes often do not tear further in the cut direction, it is also necessary to take into account the measurement samples that tear to the side. The average is calculated from the values obtained.

### Air Permeability Measurements:

Air permeabilities are determined on the basis of EN ISO 9237. The standard climate is according to DIN 50014/ISO 554; the test result is given in dm³/s*m².

### Shrinkage:

To determine shrinkage, samples measuring 100 mm×100 mm are punched out and stored in a Mathis Labdryer for one hour at 150° C. or 200° C. The shrinkage of the samples is then determined.

### Pore Sizes:

Pore sizes are determined in accordance with ASTM D6767-16 (“Standard test method for pore size characteristics of geotextile by capillary flow test”).

### Maximum Tensile Force:

The maximum tensile force (HZK) of the materials is determined in accordance with EN 29073 T3.

The invention is explained in more detail below with reference to several examples.

### EXAMPLE 1

A PET wet-laid non-woven material 100 cm wide (thickness: 120 μm, weight per unit area: 85 g/m²) was continuously coated with 300 parts of a 35% aqueous Plextol® BV 595 dispersion from Archroma by means of a roll-coating process and dried at 150° C.

A coated non-woven material having a weight per unit area of 120.13 g/m² and a thickness of 133 μm was obtained.

### EXAMPLE 2

A PET wet-laid non-woven material 100 cm wide (thickness: 120 μm, weight per unit area: 85 g/m²) was continuously coated with 300 parts of a 40% aqueous Revacryl® SY 505 dispersion from Synthomer by means of a roll-coating process and dried at 150° C.

A coated non-woven material having a basis weight of 136.6 g/m² and a thickness of 137 μm was obtained.

### EXAMPLE 3

A PET wet-laid non-woven material 100 cm wide (thickness: 120 μm, weight per unit area: 85 g/m²) was continuously coated with 300 parts of a 45% aqueous AXILAT® D 985 dispersion from Momentive by means of a roll-coating process and dried at 150° C.

A coated non-woven material with a basis weight of 130.6 g/m² and a thickness of 135 μm was obtained.

### COMPARATIVE EXAMPLE 4

Thermally solidified polyester wet-laid non-woven material consisting of 95% binder fiber (PBT/PET, fiber diameter>1 dtex) and 5% microfiber (PET, fiber diameter<0.3 dtex). The thickness calibration of the wet-laid non-woven material was performed in-line following non-woven laydown or in a separate work step. The in-line solidification was carried out using a calender with smooth roller surfaces and the roller combinations of steel/steel, steel/scappa or steel/silicone at a temperature of 170-225° C. The line pressures for all materials were in the range from 120-230 N/mm with a weight per unit area of 85 g/m² and a thickness of 120 μm.

Physical values: Table transferred.

| | | | | Comparative |
|---|---|---|---|---|
| | Example 1 | Example 2 | Example 3 | Example 4 |
| Thickness [μm] | 133 | 137 | 135 | 120 |
| Weight [g/m²] | 128.13 | 136.6 | 130.6 | 85 |
| HZK [N] (MD) | 263 | 307 | 314 | 300 |
| HZK [N] | 184 | 200 | 191 | 200 |
| WRK [N] (MD) | 0.85 | 0.87 | 0.65 | 0.43 |
| WRK [N] (CD) | 0.74 | 0.76 | 0.9 | 0.54 |
| Average | 2822 | 2796 | 2474 | 2114 |
| luminance | | | | |
| [cd/m2] | | | | |
| Scatter of | 115 | 129 | 143 | 184 |
| luminance | | | | |
| (sigma) [cd/m2] | | | | |
| Shrinkage [%] | <1 | <1 | <1 | <1 |
| Gurley count sec. | >250 | >250 | >250 | <100 |
| [100 ml] | | | | |
| Porosity [%] | 25 | 29 | 28 | 51 |

The table above shows that Examples 1-3 according to the invention have, at comparable weights per unit area and thicknesses, a higher luminance and at the same time a lower scatter (standard deviation 6) of the luminance than Comparative Example 4. This indicates that they have a greater uniformity.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method of using a non-woven material, preferably a wet-laid non-woven material, as a light-distribution element, comprising:
providing the non-woven material, the non-woven material comprising:
(a1) 1-50 wt % matrix fibers;
(a2) 50-99 wt % of at least partially thermally fused binder fibers; and
(b) 20-200 wt % of at least one filler polymer,
wherein the proportions by weight of matrix fibers, at least partially thermally fused binder fibers, and at least one filler polymer in each case relate to a total weight of the non-woven material without the at least one filler polymer,
wherein
the matrix fibers comprise at least one matrix fiber polymer and the at least partially thermally fused binder fibers comprise at least one binder fiber polymer,
wherein the at least one matrix fiber polymer and/or at least one binder fiber polymer independently of one another have a refractive index “n” of 1.3 to 1.7,
wherein the at least one filler polymer has a refractive index “n” of 1.2 to 1.7,
wherein a difference between the refractive index of the at least one matrix fiber polymer and the refractive index of the at least one filler polymer and/or a difference between the refractive index of the at least one binder fiber polymer and the refractive index of the at least one filler polymer is from 0.1 to 0.4, and
wherein the non-woven material has a Gurley count >250 sec/100 ml.

2. The method according to claim 1, wherein the non-woven material has a porosity of less than 30%.

3. The method according to claim 1, wherein the at least one filler polymer takes comprises a flat coating.

4. The method according to claim 1, wherein the at least one filler polymer is selected from a group consisting of polyacrylates, polymethacrylates, polyurethane acrylates and polyurethane methacrylates, polyurethanes, polyamides, polyvinyledene fluoride (PVDF), polyether ether ketone (PEEK), polycarbonate (PC), polyolefins (PO), cyclic polyolefin copolymers (COC), and mixtures thereof.

5. The method according to claim 1, wherein the non-woven material has an average luminance of more than 2200 cd/m and/or a scatter sigma of less than 180 cd/m².

6. The method according to claim 1, wherein the non-woven material has a tear propagation resistance in at least one direction of more than 0.6 N.

7. The method according to claim 1, wherein the non-woven material fabric has a maximum tensile strength in at least one direction of more than 180 N.

8. The method according to claim 1, wherein the non-woven material fabric has a thickness of 30 to 400 μm.

9. The method according to claim 1, wherein the non-woven material has a shrinkage of less than 2%.

10. The method according to claim 1, wherein the at least one filler polymer is produced starting from a filler polymer educt having a melting point and/or softening point which is below a melting point of the at least one matrix fiber polymer and/or of the at least one binder fiber polymer.

11. The method according to claim 1, wherein the non-woven material comprises light-scattering fillers having a refractive index of more than 1.6.

12. The method according to claim 1, wherein the matrix fibers have an average titer of 0.06 to 1.7 dtex and/or the at least partially thermally fused binder fibers have an average titer of 0.2 to 2.2 dtex.

13. The method according to claim 1, wherein the non-woven material has a density of at least 0.4 g/cm³.

14. The method according to claim 1, wherein the non-woven material has a single-layer construction.

15. A light source, comprising:
at least one illumination device; and
a light-distribution element comprising the non-woven material according to claim 1.

16. The method according to claim 1, wherein the at least one matrix fiber polymer and/or at least one binder fiber polymer independently of one another have a refractive index “n” of 1.5 to 1.65.
